(19) United States
(12) Patent Application Publication
(10) Pub. No.: US 2015/0304425 A1
(43) Pub. Date: Oct. 22, 2015

(54) DYNAMIC USER INTERFACE

(71) Applicant: THOMSON LICENSING, Issy les Moulineaux (FR)

(72) Inventors: Sylvia Park-Ekecs, Newbury Park, CA (US); Edwin Price, Long Beach, CA (US)

(21) Appl. No.: 14/648,719

(22) PCT Filed: Dec. 3, 2012
(86) PCT No.: PCT/US12/67578

§ 371 Date: Jun. 1, 2015

(51) Int. Cl. H04L 29/08; H04W 4/14; G06F 3/0481

(52) U.S. Cl. CPC H04L 67/125; G06F 3/04817; H04W 4/14

(57) ABSTRACT

Various implementations address user interfaces, and providing useful information in a user interface. Examples include providing a history of applications used to access an item or communicate with an item, or a list of serially-tasked applications that were accessed after the item was accessed, or even accessed from the item. In one particular implementation, an indication of an item is provided on a user-interface, along with an indication of an application that can be used to interact with the item. The application is determined according to a dynamic attribute of the item.

### TECHNICAL FIELD

Implementations are described that relate to information processing. Various particular implementations relate to providing information in a user interface.

### BACKGROUND

User interfaces provide an indication of available documents and applications. However, user interfaces often do not provide useful information to a user beyond the indications of the available documents and applications. There is a continuing need for more helpful user interfaces.

### SUMMARY

According to a general aspect, an indication of an item is provided on a user-interface. Further, an indication is provided of an application that can be used to interact with the item. The application is determined according to a dynamic attribute of the item.

The details of one or more implementations are set forth in the accompanying drawings and the description below. Even if described in one particular manner, it should be clear that implementations may be configured or embodied in various manners. For example, an implementation may be performed as a method, or embodied as an apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIGS. 1-4 provide pictorial representations of a sequence of four screen shots in a first implementation of a user interface.

FIGS. 5-6 provide pictorial representations of a sequence of two screen shots in a second implementation of a user interface.

FIGS. 7-8 provide pictorial representations of portions of two screen shots related to variations of the implementation of FIGS. 5-6.

FIGS. 9-10 provide pictorial representations of a sequence of two screen shots in a third implementation of a user interface.

FIGS. 11-14 provide pictorial representations of a sequence of four screen shots in a fourth implementation of a user interface.

FIG. 15 is a flow diagram depicting an implementation of presenting a dynamic user interface.

FIG. 16 is a flow diagram depicting an implementation of processing to provide a dynamic user interface.

FIG. 17 is a block diagram depicting an example of a system providing a user interface.

### DETAILED DESCRIPTION

The inventors have determined various manners in which user interfaces can be more helpful. One such manner is based on the inventors' recognition that it would be helpful to see a multi-application use history visually, or in a list view, from a top level such as an idle or a widget screen. A list view shows, in at least one implementation, a list of applications. A top level refers, for example, to a top level of a user interface, in which the top level is typically, or even always, visible and/or accessible to a user. A second such manner is based on the inventors' recognition that it would be helpful for a user to see which applications were used in relation to the user's tasks and activities. Various implementations are directed to these recognitions.

As a preview of some of the features presented in this application, a particular implementation allows a user to select a document icon being displayed on a computer screen. The implementation then automatically provides smaller icons of the last three applications that were used to open that document. The three smaller icons are provided under the document icon, in an ordered manner. A first small icon represents the most recently used application, and is positioned immediately under the document icon. A second small icon represents the next most recently used application, and is positioned immediately under the first small icon. A third small icon represents the third most recently used application, and is positioned immediately under the second small icon. Thus, the user is provided a visual display of the three most recently used applications that have been most recently used to open the document. The provision of the three smaller icons, in an ordered manner, provides the user valuable information about the use history of the document. Further, given the proliferation in types of documents and numbers of applications on a typical user computer system, the provision of use history information can be a valuable tool for a user.

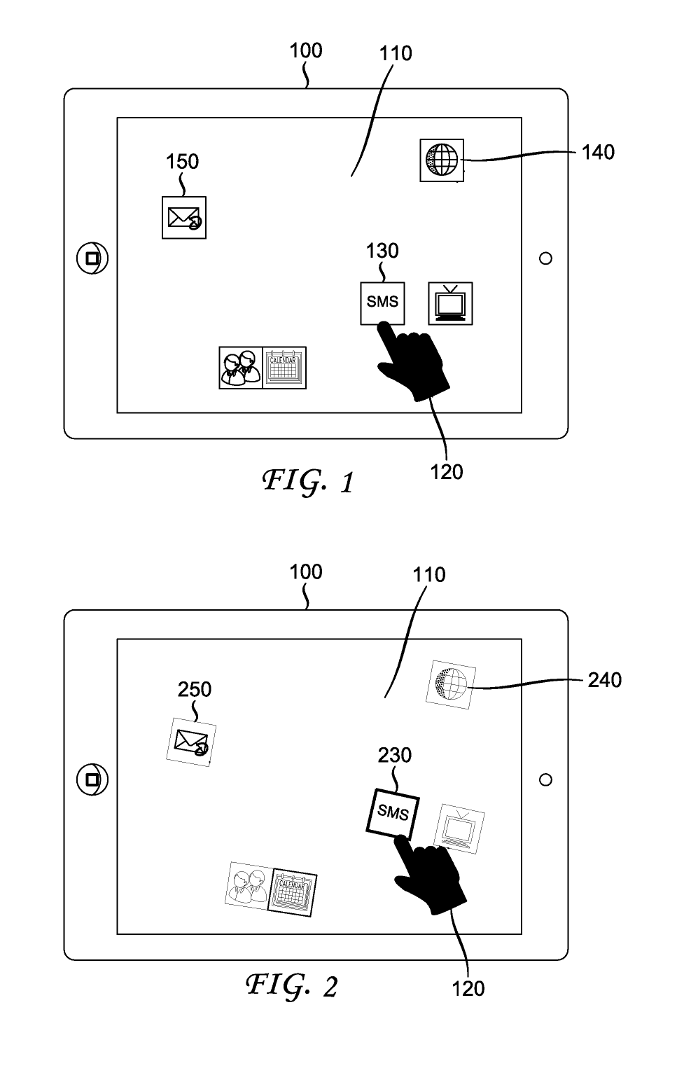

Referring to FIGS. 1-4, pictorial representations are provided of a sequence of four screen shots in a first implementation of a user interface. This implementation provides an indication, for a given item (for example, a Short Message Service (“SMS”) application such as a text message application), of applications that have been serially tasked. FIGS. 1-4 will be discussed in turn below, after discussing some variations of serially tasked applications.

In various implementations, a system keeps track of all applications that are launched after an SMS application (for example, by opening a browser application after reading a text message), or of all applications that are launched from within the SMS application (for example, by opening a browser from within a text message by clicking on a hyperlink in the text message). Additional variations track the next several (for example, three to five) applications that are launched, and/or applications that are launched within a particular time limit or threshold. The SMS application is only an example of a base application from which to track serially tasked applications. Accordingly, serially tasked applications are tracked with respect to other applications as well.

Referring to FIG. 1, a tablet 100 includes a screen 110. Positioned near the bottom of the screen 110, and shown as an overlay, is a pointer 120 in the form an outline of a hand with a pointing finger. The screen 110 displays a series of icons, including an SMS icon 130, a browser icon 140, and an email icon 150.

Prior to the point in time depicted in FIG. 1, it is assumed that the user received a text message that included a link to an event invitation. The user opened the text message using an SMS application represented by the SMS icon 130, and clicked on the link to the event invitation. Clicking on the link caused a browser application, represented by the browser icon 140, to open the event invitation. The user decided to attend the event, and clicked on a link to send an email to the event organizer. Clicking on the link caused an email application, represented by the email icon 150, to open an email message. The user composed the email message and sent the email message using the email application represented by the email icon 150.

A week later, the user wants to review the event information, but cannot remember exactly where she saw the event information. However, the user recalls receiving a message through the SMS application. To find the event information, using the SMS application, the user wants to use a serially-tasked-applications feature to determine the applications that were serially-tasked after the SMS application. At this point, we are at FIG. 1.

The serially-tasked-applications feature is invoked using a user interface control, such as, for example, by long tapping the SMS icon 130 or using a button. FIG. 1 illustrates a long-tap of the SMS icon 130 by the pointer 120. The result is shown in FIG. 2.

Referring to FIG. 2, the screen 110 continues to show the pointer 120. However, the screen 110 now displays an SMS icon 230, which is a brightened version of the SMS icon 130. The SMS icon 230 has also moved with respect to the position of the SMS icon 130, and in various implementations is animated or wobbling. The brightness, and the movement or animation, conveys the fact that the serially-tasked-applications feature has been invoked for the SMS icon 230. The other icons in the screen 110 are also moved, with respect to their positions in FIG. 1, or perhaps animated. The screen 110 of FIG. 2 includes a browser icon 240 and an email icon 250, which are moved (or animated) versions of the browser icon 140 and the email icon 150, respectively. The movement of these icons 240 and 250, with respect to the positions of the icons 140 and 150, respectively, further indicates that the serially-tasked-applications feature has been invoked for an item on the screen 110.

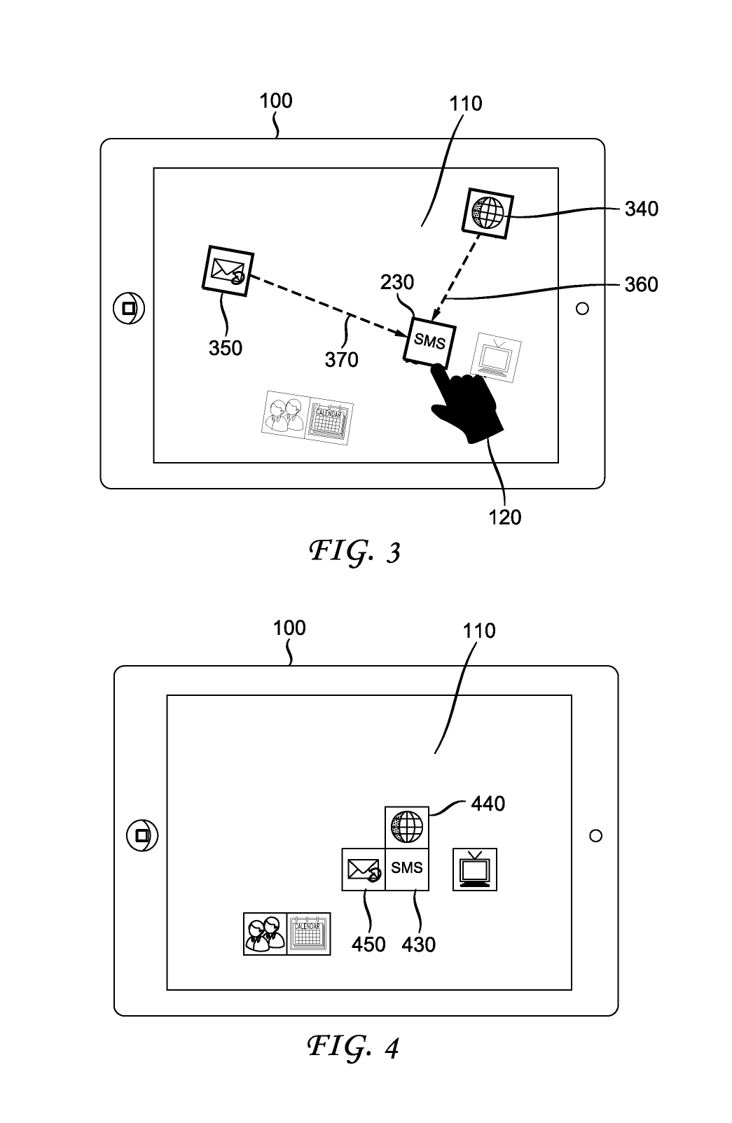

Referring to FIG. 3, the screen 110 is shown a short moment after the long-tap of the SMS icon 130. The screen 110 continues to show the pointer 120 and the brightened SMS icon 230. However, the screen 110 shows the next step in the execution of the serially-tasked-applications feature. Specifically, the screen 110 includes a browser icon 340 and an email icon 350 which are brightened versions of the browser icon 240 and the email icon 250. The icons 340 and 350 are brightened to indicate that the applications represented by the icons 340 and 350 were serially tasked after the SMS application. A number of options, discussed further below, are available to control and filter which serially tasked applications are indicated.

The screen 110 also includes a first bright arrow 360 extending from the browser icon 340 to the SMS icon 230, and a second bright arrow 370 extending from the email icon 350 to the SMS icon 230. The bright arrows 360 and 370 further indicate the associated applications were serially tasked after the SMS application.

After the point in time shown by FIG. 3, but before the point in time shown by FIG. 4, the icons 340 and 350 associated with the two serially-tasked applications are automatically snapped to the SMS icon 230. The snapping results in the icons 340 and 350 being positioned adjacent to the SMS icon 230. Further, the snapped icons 340 and 350 are snapped in the order of their serial tasking. That is, the browser icon 340 is snapped to the SMS icon 230 first, and the email icon 350 is snapped to the SMS icon 230 second. After the snapping of the two icons is completed, the brightness is removed from the icons 230, 340, and 350.

A number of options are available to provide a more enduring indication of the order of the serially tasked applications. In one implementation, there is a noticeable delay between snapping the browser icon 340 and snapping the email icon 350. In a second implementation, the snapped icons are positioned near the SMS icon 230 in order, such as, for example, by positioning the browser icon 340 closer than the email icon 350, with respect to the SMS icon 230.

Additionally, all icons in the screen 110 of FIG. 3 that were not snapped are returned to the positions occupied in FIG. 1. The snapped icons 340 and 350 remain adjacent to the SMS icon 230, even after the SMS icon 230 is returned to the FIG. 1 position.

Referring to FIG. 4, the resulting arrangement is shown. The screen 110 of FIG. 4 includes an SMS icon 430, which corresponds to the SMS icon 130. The screen 110 of FIG. 4 also includes a browser icon 440, which corresponds (for example) to a repositioned version of the browser icon 140. The screen 110 of FIG. 4 also includes an email icon 450, which corresponds (for example) to a repositioned version of the email icon 150. The serial-tasking history the SMS icon 430 is visually preserved, at least in part, by the repositioning reflected in the snapped icons 440 and 450.

In other implementations, the user may have separately opened the browser application, perhaps even exiting the SMS application first, rather than launching the browser application from within the SMS application. Additionally, the user may have separately opened the email application, perhaps even exiting the browser application, rather than launching the email application from within the browser application. In such implementations, the system tracks the serial-tasking history without regard to the manner in which subsequently used applications are launched.

Various implementations discussed above with respect to FIGS. 1-4 provide serial-tasking information for a given item by logging, for each given item, the tasks that are initiated after using the item. Certain implementations track, for example, the three tasks that are initiated after using a given item. In one implementation, each time the given item is initiated, the next three tasks are logged and overwrite any previously logged information. Other implementations keep the historical data and provide as output, for example, the most commonly serially-initiated tasks for the given item. Other implementations provide the most common serially-initiated tasks for a collection of items, such as, for example, the most common serially-initiated tasks for all browsers, or all word processing application, or all SMS applications.

Other implementations keep historical data for a specified period of time (for example, one week or one month). In such implementations, considering the example of FIGS. 1-4, the user can determine, one week after receiving the event invitation, the serially-initiated tasks for the SMS application 130 for the particular day on which the event invitation was received. The historical data provides, in various implementations, a complete listing of all serially-initiated tasks from that day, or the most common serially-initiated tasks for that day.

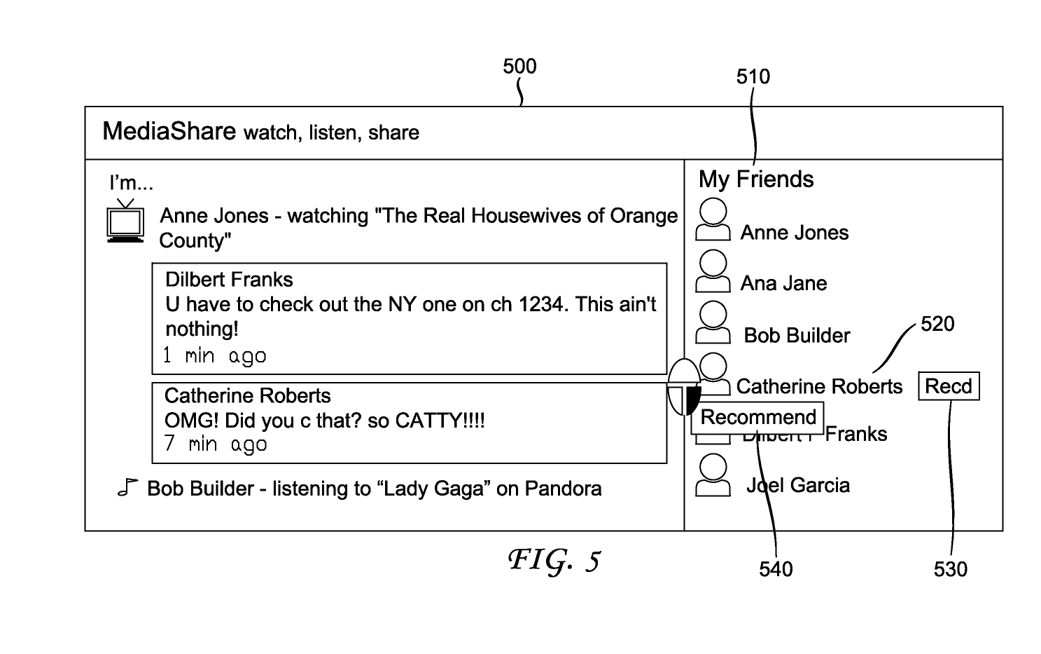

Referring to FIGS. 5-8, pictorial representations are provided of a sequence of four screen shots in a second implementation of a user interface. This implementation provides an indication, for a given item (a friend), of an ordered set of recommendations. FIGS. 5-8 will be discussed in turn below.

Referring to FIG. 5, a social media screen 500 is shown. The social media screen 500 includes a listing of friends 510, and the listing 510 includes a friend 520 named Catherine Roberts. The screen 500 includes a recommend button 530, and a recommend menu option 540 that appears upon, for example, right-clicking a mouse that is hovering over the friend 520. Both the recommend button 530 and the recommend menu option 540 can be used to invoke the same function, as explained below.

The social media site allows the user to see what her friends are watching, listening to, and sharing. The user wants to see what the friend 520 recommends. To do so, the user selects either the recommend button 530 or the recommend menu option 540.

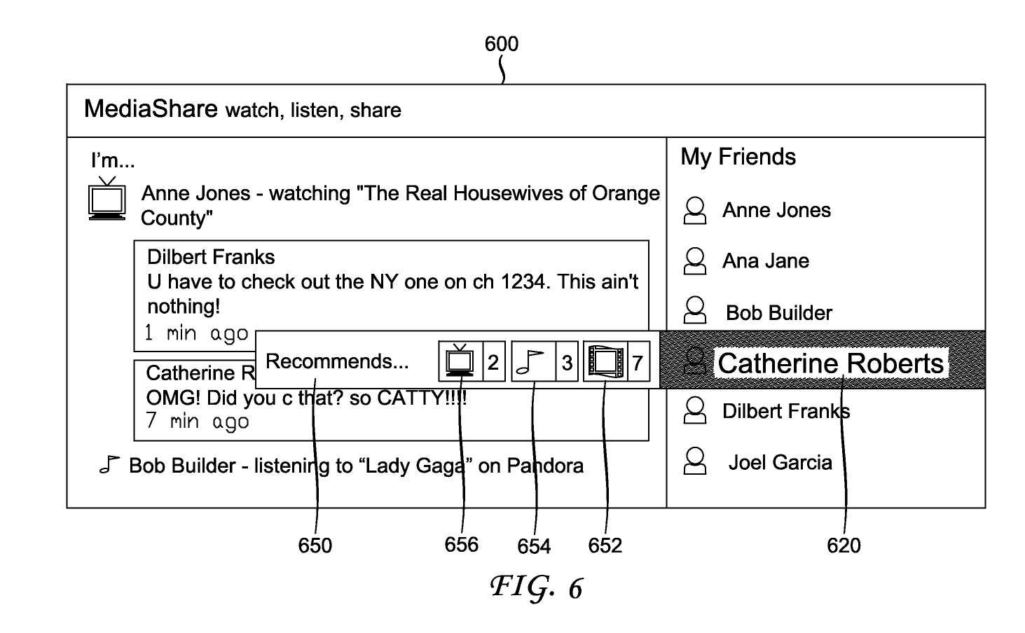

Referring to FIG. 6, a screen 600 shows the result after selecting the recommend function for the friend 520 in the screen 500. The screen 600 includes a highlighted friend 620, which is still Catherine. Adjacent to the friend 620 there has now appeared a recommendations section 650 that includes three recommendations. The three recommendations from the friend 620 are shown in three ordered recommendation sections 652, 654, and 656. A first recommendation section 652 is immediately adjacent to the friend 620. A second recommendation section 654 is adjacent to the first recommendation section 652, and further from the friend 620 than the first recommendation section 652. A third recommendation section 656 is adjacent to the second recommendation section 654, and further from the friend 620 than the second recommendation section 654.

The distance from the friend 620 to the three different recommendation sections 652, 654, and 656 indicates degree. For example, in some implementations, the distance from the friend 620 indicates a degree of recommendation. Thus, the item in the first recommendation section 652 is recommended the most by the friend 620.

The first recommendation from the friend 620 is shown as a movie, and has a number in the first recommendation section 652 of 7. The recommendation is for a single movie, and the name of the movie can be obtained through various mechanisms, such as, for example, clicking or hovering. The number 7 indicates the degree of the recommendation (a higher number is a higher recommendation).

In a manner analogous to the first recommendation, it can be seen that the second recommendation from the friend 620 is shown as a song, and the song has a recommendation level of 3. Similarly, the third recommendation from the friend 620 is shown as a television (“TV”) show, and the TV show has a recommendation level of 2.

In other implementations, the first recommendation is for the category of “movies” and not for a specific movie, and the number 7 indicates the number of recommendations in the category. Hence, with 7 movie recommendations, the movie category would be the most highly recommended category. Similarly, the second recommendation is for the category of songs, with 3 songs being recommended. And finally, the third recommendation is for the category of TV shows, with 2 shows being recommended.

Referring to FIG. 7, another implementation is presented using a recommendations section 750 that orders recommendations from top to bottom. The recommendations section 750 uses the top recommendation position for an item, if any, that is currently being played, viewed, etc. by the friend 620. Thus, a TV show 752 (The Real Housewives of Orange County) that is currently being watched by the friend 620 is, by default, the highest recommended piece of media, and occupies the top position in the list of recommended media. The second recommended piece of media is another TV show 753 (Tudors). The third recommended piece of media is a song 754 referred to as Katy Perry Firework. Thus, this implementation provides recommendations from the friend 620 combined with real time status feedback of the friend's media consumption.

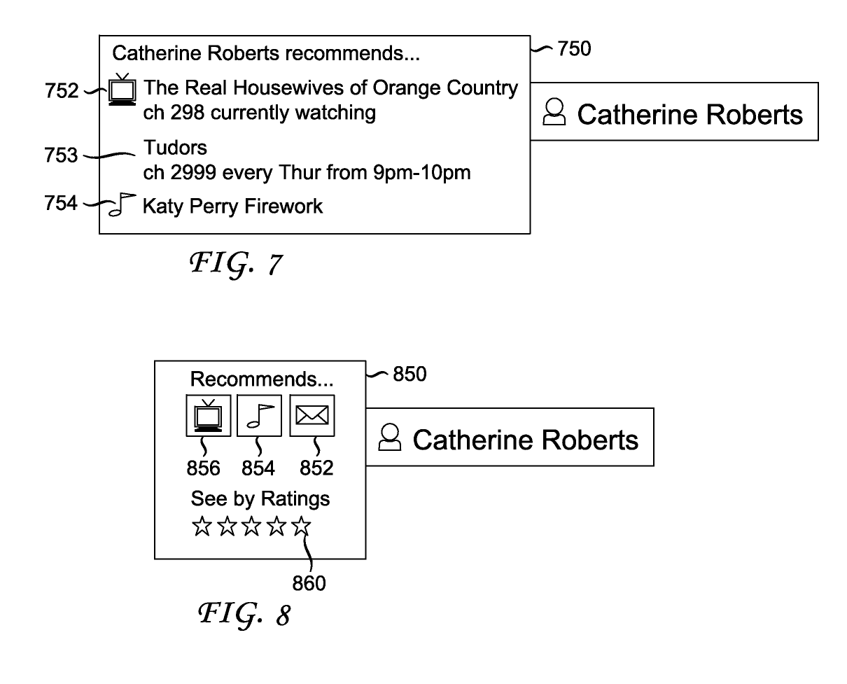

Referring to FIG. 8, another implementation is presented using a recommendations section 850. The recommendations section 850 rank orders the recommendations according to distance from the friend 620. This is the same ranking mechanism as in the recommendations section 650. Thus, an email 852 is the highest recommended piece of media, followed by a song 854, and then followed by a TV show 856. The recommendations section 850 only includes pieces of media that are recommended by the friend 620. However, those pieces of media are not rank-ordered according to the ranking provided the friend 620. Rather, those pieces of media are rank-ordered according to objective ratings provided, for example, by a content provider or a rating service. Thus, of all of the pieces of media recommended by the friend 620, the email 852 has the highest objective rating level and is, therefore, placed closest to the friend 620 in the recommendations section 850. This implementation thus provides recommendations from the friend 620 combined with objective rating levels.

Other implementations allow, for example, a picture icon of a friend (in a social media application) to have media recommendations appear near the friend's icon when you select the friend. As above, the distance of the media recommendation from the friend's icon indicates how much the friend recommends the various media recommendations.

In most of the implementations discussed with respect to FIGS. 5-8, the information on recommendations is tracked, stored, and provided by the social media site. The ordered set of recommendations is provided by accessing the available recommendations (and available current consumption, and available objective ratings), and rank-ordering those recommendations, and displaying the rank-ordered recommendations in a hierarchical manner as explained above.

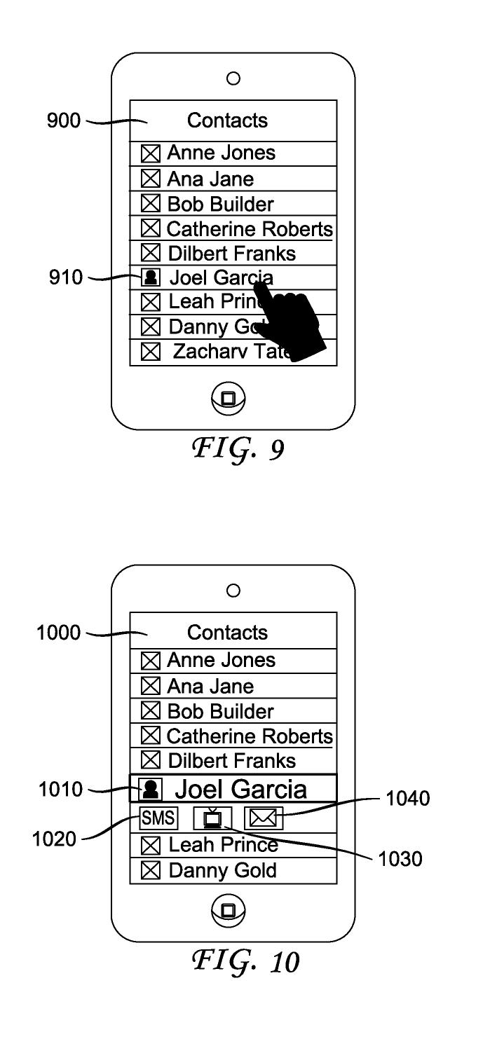

Referring to FIGS. 9-10, pictorial representations are provided of a sequence of two screen shots in a third implementation of a user interface. This implementation provides an indication, for a given item (a contact), of an ordered set of communication options. FIGS. 9-10 will be discussed in turn below.

Referring to FIG. 9, a contacts screen 900 is shown. The contacts screen 900 includes a listing of people including a contact 910, which is Joel Garcia. The screen 900 shows that the contact 910 is about to be selected.

Referring to FIG. 10, a contacts screen 1000 is shown that is produced after the contact 910 is selected in the screen 900. The screen 1000 includes a selected contact 1010, which is Joel Garcia. Additionally, upon selection of the contact 910, a set of hierarchically arranged communication applications or services are displayed adjacent to the selected contact 1010.

Three communication services are displayed in the screen 1000. These are indicated by (i) an SMS icon 1020, (ii) a TV icon 1030, and (iii) an email icon 1040. The three icons 1020, 1030, and 1040 are ordered, from left to right, under the selected contact 1010, in order of highest preference. Thus, the most preferred communication mechanism between the user and the selected contact 1010 is texting (indicated by the SMS icon 1020), followed by video sharing (indicated by the TV icon 1030), followed by email (indicated by the email icon 1040).

Other implementations provide additional communication options, such as, for example, telephone. Additionally, various implementations provide the rank-ordered communication options for a given contact in different manners, such as, for example:
In certain implementations, each contact has storage fields available for designating first, second, and third (for example) preferred methods of communication.
Certain other implementations track all communications for a given contact. Several such implementations keep a running tally of the number of uses of each mode of communication for a given contact. The tally is kept over a fixed period of time such as, for example, a running period equal to the previous thirty days. The highest tally is the most preferred method.

Referring to FIGS. 11-14, pictorial representations are provided of a sequence of four screen shots in a fourth implementation of a user interface. This implementation provides an indication, for a given item (a location), of an ordered set of options. The options are restaurant options in this implementation. However, other implementations provide other options. Such other options include, for example, tourist attractions, gas stations, addresses from a user's contacts list, government buildings, fast-food restaurants, or schools. FIGS. 11-14 will be discussed in turn below.

Referring to FIG. 11, a screen 1100 is shown that provides a local map of Burbank identifying a location 1110 that is the current location of the user. A location-based service, for example, is used to provide the current location of the user and the local map.

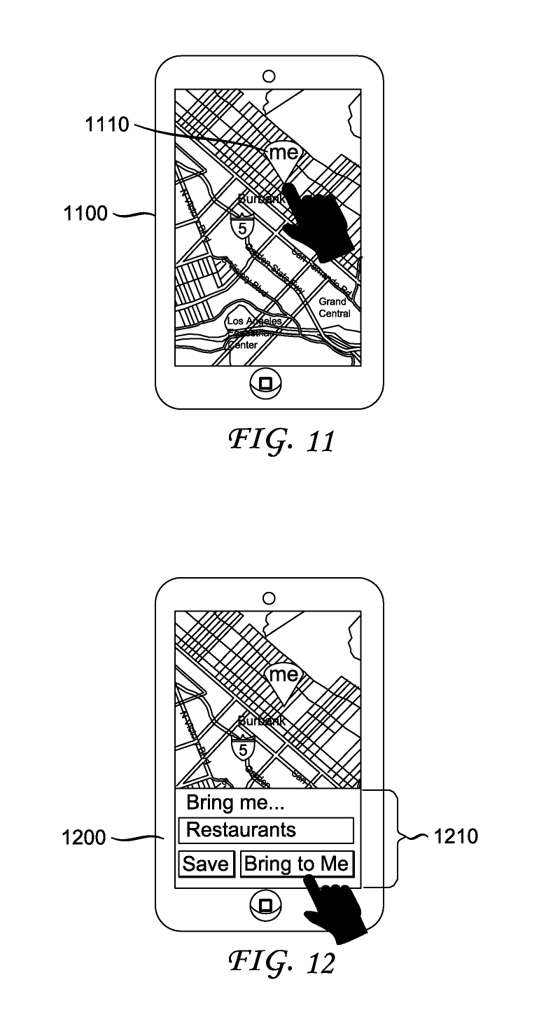

Referring to FIG. 12, a screen 1200 is shown that includes a searching section 1210. In the example of FIG. 12, the user is searching for restaurants that are near the user's current location. The location-based service, for example, is used to provide the restaurant information.

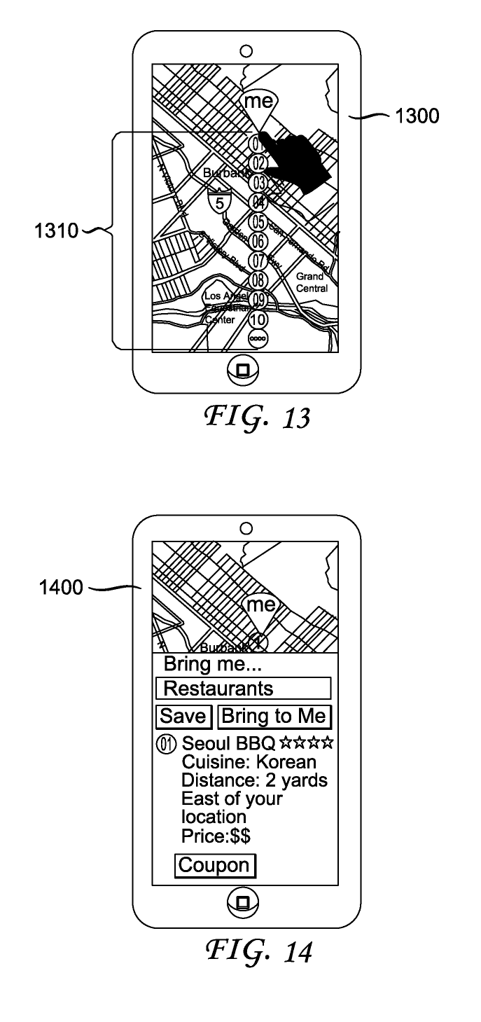

Referring to FIG. 13, a screen 1300 shows an ordered list of restaurants 1310. The list of restaurants is provided, for example, by the location-based service. The list is ordered according to one or more of a variety of different criteria. The criteria include, for example, (i) distance from the user's current location, (ii) user preference (for example, the user's preference for a particular type of food, or for a particular price range, as provided, for example, by the user's profile), (iii) rankings provided by Yelp or other sources, (iv) price range (for example, lower price results in a higher ranking, or vice versa), (v) whether a coupon is available on-line, and/or (vi) whether the restaurant has paid a fee to be rank-ordered more highly.

As with several previous implementations, the more highly ranked restaurants are placed in a position that is closer to the user's current location. Thus, restaurant choice “01” is the most highly ranked, and is placed closest to the user's current location.

Other implementations, display the restaurants options in a directional manner. That is, the restaurant recommendations are shown in the direction of the actual restaurant. However, the distance between the user's current location and the displayed restaurant recommendation is still reflective of the level of the ranking. Accordingly, if the user was walking to the north, the user may prefer to select a restaurant that is in a northerly direction. The user would be able to see, for example, and at a quick glance, the most highly ranked restaurant that is in a northerly direction.

Referring to FIG. 14, a screen 1400 shows the result after the user selects restaurant choice “01”, which is a Korean BBQ restaurant. The screen 1400 also shows that a coupon is available for restaurant “01”.

Various implementations relate to documents stored on a computer, for example. In certain of these implementations, various lists can be generated and the list, or corresponding icons, can be displayed for a given document. These lists include, for example:
A list of all applications that can be used to open the document. For example, for a text document, all word processors would be listed. The list can be generated by tracking, and tagging if needed, all word processor applications that are stored on a computer. The tracking can be done, for example, by generating a table of all applications, with the table including fields for the type of application. The type of application can be determined, for example, by the application itself, by searching for information on the Internet that will identify the type of application for a given application name, or by a user entering data. Upon selection of the document, the icons for the applications that are on the corresponding list can be generated and displayed in a manner analogous, for example, to the icons 1020-1040 of FIG. 10.
A list of all applications that have been used to open the document. For example, a picture may be opened by a variety of applications. A list is kept, for each given document, of all applications that have been used to open the document. The list can be rank-ordered by, for example, (i) the date accessed so that the system can display, for example, the most recently used application first, or (ii) the frequency of access, so that the system can display, for example, the most frequently used application first. The applications can be tracked using standard processes, such as, for example, by comparing file names (including the full path). Upon selection of the document, the icons for the applications that are on the corresponding list can be generated and displayed in a manner analogous, for example, to the icons 1020-1040 of FIG. 10.

Various implementations operate over networks, and not simply single computer systems. In one such implementation, a list is generated for a given stored object (for example, a movie, a word processing document) that indicates all of the locations on the network at which the object is stored. For example, in a home network, a user might select a particular CD, and upon selecting the CD or upon selecting the list feature (using, for example, a right-click of a mouse), a list would be accessed showing that the CD is stored on a laptop, a DVR, and two external hard drives. The list entries can also be rank-ordered according to, for example, the date of the copy of the CD, or the distance from the current networked device to the location of the copy of the CD. Upon selection of the object, the icons for the laptop, DVR, and two hard drives, can be displayed in a manner analogous, for example, to the icons 1020-1040 of FIG. 10.

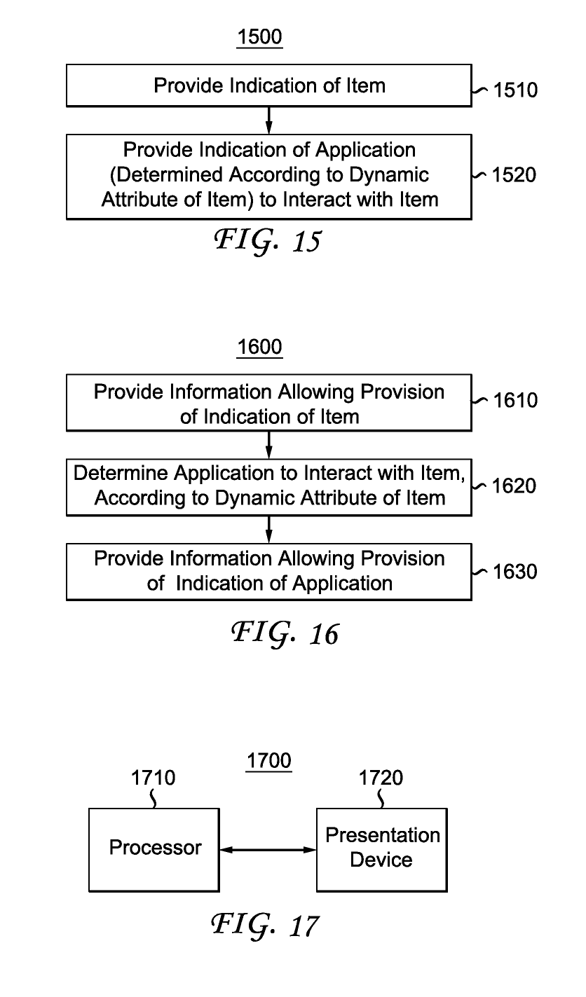

Referring to FIG. 15, a flow diagram illustrates a process 1500 depicting an implementation of presenting a dynamic user interface. The process 1500 also depicts a structure for performing the recited operations of the process 1500.

The process 1500 includes providing an indication of an item (1510). The indication of the item is provided, in at least one implementation, on a user-interface. The indication of the item includes, for example, the visual display of (i) the SMS icon 130, 230, or 430, (ii) the friend 520 or 620, and/or (iii) the contact 910 or the selected contact 1010.

The process 1500 also includes providing an indication of an application that can be used to interact with the item, with the application having been determined according to a dynamic attribute of the item (1520). The indication of the application is provided, for example, on a device that may be different from, or the same as, the user-interface device used in the operation 1510. The indication of the application is provided, for example, concurrently with the provision of the indication of the item in the operation 1510.

Providing two indications concurrently means that the two indications are provided in at least an overlapping period of time. This allows a user, for example, to see both indications on a display simultaneously for at least a period of time. In one implementation, for example, a first indication is displayed from time t0 through time t3, and a second indication is displayed from a time t1 through time t4. Thus, both indications are displayed at the same time during the time t1 through time t3, in which time t1 through time t3 is an overlapping period of time. Therefore, both indications are said to be displayed concurrently.

An “application”, as used in this document is intended to distinguish from, for example, “data”. An application generally involves the use of software to perform a function. That software can be, for example, compiled code or interpreted code. An application can also refer to a specific application, such as, for example, a particular word processing application produced by a specific company. However, an application can also refer to a class of applications, such as, for example, an email application, an SMS application, or a word processing application.

An “item”, as used in this application is intended to be a broad term that includes, for example, applications as well as data. Examples of an “item” include an SMS application (see, for example, FIG. 3), a social networking “friend” (see, for example, FIG. 6), a contact name (see, for example, FIG. 10), and a location (see, for example, FIG. 11).

A “user interface” or “user interface device”, as used in this application is intended to be a broad term that includes any device or component capable of providing at least one-way communication with a user in any form. User interfaces include, for example, a speaker, a display, a microphone, a keyboard, or a mouse.

The indication of the application includes, for example, the visual display of (i) the browser icon 340, which can be used to interact with the SMS icon 230, (ii) the email icon 350, which can be used to interact with the SMS icon 230, (iii) the SMS icon 1020, which can be used to interact with the selected contact 1010, and/or (iv) the email icon 1040, which can be used to interact with the selected contact 1010. In the implementations of FIGS. 3 and 10, for example, the indications of the item and of the application are displayed concurrently on the same user-interface device, which is the screen 110 and the contact screen 1010, respectively.

Many implementations described in this application are performed entirely, or primarily, on a single user-interface device. Such devices include, for example, a tablet, a cell phone, and/or a laptop. However, other implementations are distributed, with most of the processing and storage occurring on one or more devices that are separate from the user-interface device. In several such implementations, a networked computer system stores the applications and the documents, and provides information to a user-interface device that is used principally as a display and input device.

In one such implementation, a networked computer stores a word processing application and an associated icon, and a word processing document and an associated icon. The computer sends communication information, including the icons, to a remote user interface. This information allows the user interface to access the word processing application and document that are stored on the networked computer.

In this implementation, the networked computer maintains, for example, the use history of the word processing document. Accordingly, when a user requests use history information, the networked computer determines, based on this use history, that, for example, the word processing application is the most recent application to access the word processing document. The networked computer then sends information to the user interface allowing the user interface to provide a display in which, for example, the word processing icon is snapped to the word document icon.

Referring to FIG. 16, a flow diagram illustrates a process 1600 depicting an implementation for performing processing to provide a dynamic user interface. The process 1600 also depicts a structure for performing the recited operations of the process 1600.

The process 1600 includes providing information allowing the provision of an indication of an item (1610). The indication of the item is provided, for example, on a user-interface device. The networked computer described just above provides, for example, information allowing the icon for the word processing document to be provided on the user interface. The user interface of this implementation receives the information and provides the icon on the display of the user interface.

The process 1600 also includes determining, based on a dynamic attribute of the item, an application that can be used to interact with the item (1620). The networked computer described just above determines, for example, that the word processing application can be used to interact with the word processing document. Further, the networked computer determines, based on the use history, that the word processing application satisfies the attribute of being the most recent application to access the word processing document. Because different applications can access the word processing document, being the most recent application to access to the word processing document is a dynamic attribute.

The process 1600 also includes providing information allowing the provision of an indication of the application (1630). The information of at least one implementation also identifies the application. Further, the information allows the indication of the application to be provided, in various implementations, (i) concurrently with the indication of the item (using the information provided in the operation 1610), and (ii) on the same, or a different, user-interface device as is used to provide the indication of the item (using the information provided in the operation 1610). The networked computer described just above provides, for example, information identifying the word processing application, and allowing the user interface to snap the word processing icon to the icon for the word processing document.

Additional implementations of the process 1600 are also provided throughout this application. For example, the tablet 100 (i) provides the information to its internal display controller to brighten the SMS icon 130 and thereby produce the SMS icon 230, (ii) determines that the browser icon 240 can be used to interact with the SMS icon 230, and is a serially-tasked application (a dynamic attribute) with the SMS icon 230, and accordingly (iii) provides information to brighten and snap the browser icon 240, resulting in the browser icon 340 and then the browser icon 440.

As another example, the device of FIGS. 9-10 (i) provides the information to its internal display controller to highlight the selected contact resulting in the selected contact 1010, (ii) determines that the SMS application represented by the SMS icon 1020 can be used to interact with the selected contact 1010, and is the preferred communication method (a dynamic attribute) of the selected contact 1010, and accordingly (iii) provides information to display the SMS icon 1020 at the left-most position under the selected contact 1010.

Referring to FIG. 17, a block diagram illustrates, as an implementation, a system 1700 that provides a user interface. The system 1700 includes a processor 1700 communicatively coupled to a presentation device 1720. The system 1700 is, in various implementations, an integrated device that includes both the processor 1710 and the presentation device 1720. In other implementations, however, the system 1700 is a distributed system in which the processor 1710 is distinct from, and remotely located with respect to, the presentation device 1720.

The processor 1710 is, for example, any of the options for a processor described throughout this application. The processor 1710 can also be, or include, for example, the processing components inherent in the devices shown or described with respect to FIGS. 9-14.

The presentation device 1720 is, for example, any device suitable for providing any of the indications described throughout this application. Such 3o devices include, for example, all user interface devices described throughout this application. Such devices also include, for example, the display components shown or described with respect to FIGS. 1-14.

Various implementations have been described that provide an indication of, for example, an item or an application. Such indications are typically sensory indications that provide an indication that is perceived by a user using one or more of the user's senses. For example, a sensory indication includes, in various implementations, a visual indication, an audible indication, or a vibratory indication.

Additionally, various presentation devices have been described. Such presentation devices are typically sensory presentation devices that present information in a sensory manner. For example, a sensory presentation device includes, in various implementations, a display for providing a visual presentation, or a speaker for providing an audible presentation.

Different implementations vary one or more of a number of features. Some of those features, and their variations, are described below:
Various implementations use different indications of, for example, an item or an application. Such indications include, for example, all or part of an icon, a link, a path name, or a file name.
Various implementations use different attributes. Such attributes include, for example, most recently used application to open a document or to communicate with a contact, most frequently used application to open a document or to communicate with a contact, or preferred application to open a document or to communicate with a contact.
Various implementations provide an indicator in different manners to indicate an attribute. Such manners include, for example, adjusting the color, shading, brightness, fading, location, or relative distance, of all or part of an indicator, to reflect the fact that a particular attribute is satisfied.
Various implementations include multiple indicators (for example, use-history applications) for a given item, and the multiple indicators are snapped to an indicator of the given item. However, the multiple indicators are stacked in a partially overlapping arrangement, with the top-most indicator being associated with the highest ranking application, and the bottom-most indicator being associated with the lowest ranking application.
Various implementations use different sensory indications. Such sensory indications include, for example, displaying an indicator, audibly speaking an indicator, providing a particular vibratory pattern, or providing other haptic (touch-based) sensory indications.

This application provides multiple block and flow diagrams, including the flow diagrams of FIGS. 15-16 and the block diagram of FIG. 17. It should be clear that the block and/or flow diagrams of this application present both a flow diagram describing a process, and a block diagram describing functional blocks of an apparatus. Additionally, this application provides multiple pictorial representations, including the pictorial representations of FIGS. 1-14. It should be clear that the pictorial representations of this application present both (i) an illustration, a result, or an output, and (ii) a flow diagram describing a process.
For example, as previously described, the flow diagram of FIG. 15 describes a flow process, including the operations listed in FIG. 15. However, FIG. 15 also provides a block diagram for implementing that flow. In one implementation, for example, (i) the block 1510 for providing an indication of an item represents a component for performing that function, and (ii) the block 1520 for providing an indication of an application represents a component for performing that function. In another implementation, FIG. 16 is interpreted in a similar manner to that just described for FIG. 15.
For example, as previously described, the block diagram of FIG. 17 describes a system or apparatus, including the components shown in FIG. 17. However, FIG. 17 also provides a flow diagram for performing the functions of the blocks. In one implementation, for example, (i) the block for the processor 1710, which is a component, represents the operation of processing, and (ii) the block for the presentation device 1720 (also a component) represents the operation of presenting, for example, information or data.
For example, as previously described, the pictorial representation of FIG. 3 provides a screen shot showing a point in time in a sequence of activities for providing an indication of serially-tasked applications. However, as previously noted, FIG. 3 also provides a flow diagram for performing all or part of the process of providing the indication of serially-tasked applications. In one implementation, for example, (i) the display of icons in the tilted arrangement, with respect to the arrangement shown in FIG. 1, represents the operation of activating, for example, a utility for showing serially-tasking applications, (ii) the first bright arrow 360 represents the operation of identifying to a user that the application associated with the icon 340 was a first serially-tasked application, and (iii) the second bright arrow 370 represents the operation of identifying to a user that the application associated with the icon 350 was a second serially-tasked application.

We have thus provided a number of implementations. Various implementations snap application icons together to show related applications at a glance, based on various combinations of, for example, the following features: (i) visualized application task history, (ii) (use) hierarchy, (iii) content attributes, (iv) media inter-relationships, and/or (v) entity categorization. Additionally, various implementations relate to one or more of the following feature keywords: application use history, use sequence, visual user-interface history, use relations, task tracking, sensory memory user-interface, human visual sensor, and/or human visual sensory memory.

Further, various implementations can be described, in whole or part, as providing a magnetic user-interface, a sticky user-interface, or an auto-sticking feature. For example, the icons that are snapped to a given icon, or that are displayed in a defined hierarchical positioning with respect to the given icon (see, for example, FIGS. 6, 10, and 13), can be said to stick to the given icon, or can be referred to as magnets attached to the given icon.

It should be noted, however, that variations of the described implementations, as well as additional applications, are contemplated and are considered to be within our disclosure. Additionally, features and aspects of described implementations may be adapted for other implementations.

Several of the implementations and features described in this application may be used in the context of the AVC Standard, and/or AVC with the MVC extension (Annex H), and/or AVC with the SVC extension (Annex G). AVC refers to the existing International Organization for

Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (referred to in this application as the “H.264/MPEG-4 AVC Standard” or variations thereof, such as the “AVC standard”, the “H.264 standard”, or simply “AVC” or “H.264”). Additionally, these implementations and features may be used in the context of another standard (existing or future), or in a context that does not involve a standard.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, memory), storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C” and “at least one of A, B, or C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Additionally, many implementations may be implemented in a processor, such as, for example, a post-processor or a pre-processor. The processors discussed in this application do, in various implementations, include multiple processors (sub-processors) that are collectively configured to perform, for example, a process, a function, or an operation. For example, the processor 1710 is, in various implementations, composed of multiple sub-processors that are collectively configured to perform the operations of the processor 1710. Further, other implementations are contemplated by this disclosure.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants (“PDAs”), and other devices that facilitate communication of information between end-users.

Implementations of the various processes and features described herein may be embodied in a variety of different equipment or applications. Examples of such equipment include an encoder, a decoder, a post-processor, a pre-processor, a video coder, a video decoder, a video codec, a web server, a set-top box, a router, a laptop, a personal computer, a tablet, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading syntax, or to carry as data the actual syntax-values generated using the syntax rules. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising:
providing, on a user-interface, an indication of an item; and
providing an indication of an application that can be used to interact with the item, the application having been determined according to a dynamic attribute of the item.

2. The method of claim 1 wherein the indication of the application is provided on a device that is different from the user-interface.

3. The method of claim 1 wherein the indication of the application is provided in a manner that indicates the dynamic attribute of the item.

4. The method of claim 1 wherein the manner includes adjusting one or more of the following characteristics for all or part of a visual display of the application: distance from a visual display of the item, location on a display, shading, brightness, fading, or color.

5. The method of claim 1 further comprising receiving a request, at least in part through the user-interface, for the indication of the application, and wherein providing the indication of the application is performed in response to receiving the request.

6. The method of claim 1 further comprising determining the application that can be used to interact with the item, the determining being based on the dynamic attribute.

7. The method of claim 1 wherein the indication of the application is provided concurrently with the indication of the item.

8. The method of claim 1 wherein the attribute comprises one or more of: the application is the most recent application to access the item, the application is the most frequently used application to access the item, or the application is the preferred application for accessing the item.

9. The method of claim 1 wherein the dynamic attribute of the item specifies one or more of (i) a preferred application for communicating with the item, or (ii) an application serially-tasked after opening the item.

10. The method of claim 1 wherein:
the item comprises a contact name,
the indication of the item comprises a visual presentation of the contact name on a display,
the application comprises an SMS application that can be used for communicating between a user and the contact name,
the indication of the application comprises an icon for the SMS application, and
the dynamic attribute comprises the attribute that the application is the preferred mechanism for communicating between the user and the contact name.

11. The method of claim 1 wherein:
the item comprises an SMS application,
the indication of the item comprises an icon for the SMS application,
the application comprises a browser application,
the indication of the application comprises an icon for the browser application, and
the dynamic attribute comprises the attribute that the browser application is part of the most recent serial-tasking from the SMS application.

12. The method of claim 1 wherein:
the user interface comprises a display,
the indication of the application is provided on the display,
the dynamic attribute of the item specifies one or more of (i) a preferred application for communicating with the item, or (ii) an application serially-tasked after opening the item, and
the method further comprises receiving, at least in part through the display, a request for the indication, and wherein providing the indication of the application is performed in response to receiving the request.

13. An apparatus comprising:
a user interface;
a processor configured to provide, on the user-interface, (i) an indication of an item, and (ii) an indication of an application that can be used to interact with the item, the application having been determined according to a dynamic attribute of the item, and the indication of the application is provided concurrently with the indication of the item.

14. The apparatus of claim 13 wherein:
the user interface comprises a first display and a second display, and the processor is configured to provide the indication of the item on the first display, and to provide the indication of the application on the second display.

15. An apparatus comprising:
means for providing, on a user-interface, an indication of an item; and
means for providing an indication of an application that can be used to interact with the item, the application having been determined according to a dynamic attribute of the item, and the indication of the application is provided concurrently with the indication of the item.

16. A processor readable medium having stored thereon instructions for causing one or more processors to collectively perform:
providing, on a user-interface, an indication of an item; and
providing an indication of an application that can be used to interact with the item, the application having been determined according to a dynamic attribute of the item, and the indication of the application is provided concurrently with the indication of the item.

17. An apparatus configured to perform one or more of the methods of claim 1.

18. A processor readable medium having stored thereon instructions for causing one or more processors to collectively perform one or more of the methods of claim 1.
